(19) United States
(12) Patent Application Publication
(10) Pub. No.: US 2025/0108703 A1
(43) Pub. Date: Apr. 3, 2025

(54) WORK VEHICLE

(71) Applicant: Kubota Corporation, Osaka (JP)

(72) Inventors: Kodai AMITANI, Sakai-shi (JP); Kenichi IWAMI, Sakai-shi (JP); Tomoyoshi SAKANO, Sakai-shi (JP); Go TAKAKI, Sakai-shi (JP); Yuki MINAMIDE, Sakai-shi (JP); Takahiro TAKAKI, Sakai-shi (JP); Yosuke HAYASHI, Sakai-shi (JP)

(21) Appl. No.: 18/978,018

(22) Filed: Dec. 12, 2024

Related U.S. Application Data
(63) Continuation of application No. PCT/JP2023/023490, filed on Jun. 26, 2023.

(30) Foreign Application Priority Data
Jun. 28, 2022 (JP) 2022-103775

(51) Int. Cl. B60L 50/70; B60K 35/10; B60K 35/22; B60K 35/28; B60L 1/00; B60L 58/30; B60Q 5/00; G07C 5/00

(52) U.S. Cl. CPC B60L 50/70; B60K 35/10; B60K 35/22; B60K 35/28; B60L 1/00; B60L 58/30; B60Q 5/005; G07C 5/004; B60K 2360/166; B60K 2360/169; B60K 2360/178; B60L 2200/40; B60L 2250/16

(57) ABSTRACT

A work vehicle includes a fuel cell module including a fuel cell stack, at least one fuel tank to store fuel to be supplied to the fuel cell stack, a sensor to measure a remaining amount of fuel in the at least one fuel tank, a motor connected to the fuel cell module, a power take-off shaft driven by the motor and to which an implement is connected, a display, and a processor configured or programmed to estimate, based on the measured remaining amount of fuel and a type of the implement connected to the power take-off shaft and/or a type of work performed by the implement, at least one of a travelable distance, a travelable area, or a travelable time with the work, and to display an estimation result on the display.

### CROSS REFERENCE TO RELATED APPLICATIONS

This application claims the benefit of priority to Japanese Patent Application No. 2022-103775 filed on Jun. 28, 2022 and is a Continuation Application of PCT Application No. PCT/JP2023/023490 filed on Jun. 26, 2023. The entire contents of each application are hereby incorporated herein by reference.

### BACKGROUND OF THE INVENTION

### 1. Field of the Invention

The present disclosure relates to work vehicles.

### 2. Description of the Related Art

In the field of motor vehicles, where the main purpose is to transport “people” or “objects,” electric vehicles (EVs) are becoming increasingly popular. In these vehicles, the driving force (traction) is generated by an electric motor (hereinafter referred to as “motor”) instead of an internal combustion engine.

On the other hand, there is a need to reduce the amount of carbon dioxide (CO₂) emitted by work vehicles, such as tractors used in agricultural fields, to realize a decarbonized society. Unlike typical automobiles, work vehicles such as tractors need to tow implements, which are work machines, to perform agricultural tasks such as plowing. Therefore, to achieve the electrification of work vehicles, there are issues to be solved that differ from those of passenger cars.

Japanese Laid-Open Patent Publication No. 2021-123177 discloses a vehicle including a fuel cell, a battery, a drive device to convert power generated by the fuel cell and battery into motive power, and a display to display an indicator showing the power output from the fuel cell and battery. The display displays information on the indicator showing a threshold used to determine whether to supply power to the drive device from either the fuel cell or battery, or from both the fuel cell and battery.

### SUMMARY OF THE INVENTION

Example embodiments of the present invention provide technologies to improve the convenience of a work vehicle equipped with a fuel cell module.

A work vehicle according to an example embodiment of the present disclosure includes a fuel cell module including a fuel cell stack, at least one fuel tank to store fuel to be supplied to the fuel cell stack, a sensor to measure a remaining amount of fuel in the fuel tank, a motor connected to the fuel cell module, a power take-off shaft drivable by the motor and to which an implement is connectable, a display, and a processor configured or programmed to estimate, based on the measured remaining amount of fuel and a type of the implement connected to the power take-off shaft and/or a type of work performed by the implement, at least one of a travelable distance, a travelable area, or a travelable time with the work, and to display an estimation result on the display.

Comprehensive or specific example embodiments of the present disclosure may be achieved by apparatuses, systems, methods, integrated circuits, computer programs, or computer-readable non-transitory storage media, or any combination thereof. The computer-readable storage media may include volatile storage media or non-volatile storage media. The apparatuses may include with a plurality of devices. When the apparatuses include two or more devices, the two or more devices may be arranged within a single equipment or may be arranged separately in two or more pieces of equipment.

According to example embodiments of the present disclosure, it becomes possible to improve the convenience of work vehicles each including a fuel cell module.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a plan view schematically showing a basic configuration example of a work vehicle according to an example embodiment of the present disclosure.

FIG. 2 is a diagram showing a basic configuration example of a fuel cell power generation system mounted on the work vehicle.

FIG. 3 is a block diagram schematically showing an example of electrical connections and power transmission between components of a work vehicle according to an example embodiment of the present disclosure.

FIG. 4 is a block diagram schematically showing paths of electrical signals (solid thin lines) and coolant paths (dotted lines) between components of a work vehicle according to an example embodiment of the present disclosure.

FIG. 5 is a perspective view schematically showing a configuration example of a work vehicle according to an example embodiment of the present disclosure.

FIG. 6 is a side view schematically showing a configuration example of a work vehicle according to an example embodiment of the present disclosure.

FIG. 7 is a block diagram showing an example hardware configuration of an operation terminal.

FIG. 8 is a diagram showing an example of a table indicating the relationship between implement types, work types, and fuel consumption.

FIG. 9A is a diagram schematically showing an example of displaying estimation results on the display when driving an implement.

FIG. 9B is a diagram schematically showing an example of displaying estimation results on the display when not driving an implement.

FIG. 10 is a diagram schematically showing another example of displaying estimation results on the display.

FIG. 11 is a diagram schematically showing an example of a display including information prompting fuel replenishment.

FIG. 12 is a diagram schematically showing an example of a popup display including information on travelable time.

FIG. 13 is a diagram schematically showing an example of a display including map information.

FIG. 14 is a flowchart showing an example of the processing procedure for the operation of the processor.

### DETAILED DESCRIPTION OF THE EXAMPLE EMBODIMENTS

The following describes example embodiments of the present disclosure. However, excessively detailed explanations may be omitted. For example, detailed explanations of well-known matters and repetitive explanations of substantially identical configurations may be omitted. This is to avoid the following description from becoming redundant and to unnecessarily facilitate understanding by those skilled in the art. The inventors provide the attached drawings and the following description to enable those skilled in the art to fully understand this disclosure, and do not intend to limit the subject matter described in the claims these drawing and description. In the following description, the same reference numerals are used for components with the same or similar functions.

The following example embodiments are illustrative and not limiting. The technologies disclosed herein are not restricted to the following example embodiments. For instance, the numerical values, shapes, materials, steps, the order of those steps, screen layouts, and other elements shown in the following example embodiments are merely examples. Various modifications can be made as long as no technical contradictions arise. Additionally, different feature, elements, characteristics, etc., of the example embodiments may be combined as long as there are no technical contradictions.

In this disclosure, the term “work vehicle” refers to a vehicle used to perform a task at a work site. A “work site” includes any place where work is carried out, such as a field, forest, or construction site. A “field” refers to any place where agricultural work is performed, such as an orchard, farm, paddy field, grain farm, or pasture. A work vehicle may include an agricultural machine such as a tractor, rice planter, combine harvester, riding field management vehicle, or riding mower, as well as a non-agricultural vehicle such as a construction work vehicle or snowplow. The work vehicles described in this disclosure may be equipped with an implement (also called a “work machine” or “work device”) attached to at least one of its front and rear portions, depending on the nature of the work. Travel of a work vehicle while performing a task may be referred to as “tasked travel.”

An “agricultural machine” refers to a machine for agricultural application. Examples of agricultural machines include tractors, harvesters, rice planters, riding field management vehicles, vegetable transplanters, mowers, seeders, spreaders, and agricultural mobile robots. Not only may a work vehicle such as a tractor function as an “agricultural machine” on its own, but also the entire combination of a work vehicle and an implement attached to or towed by the work vehicle may function as an “agricultural machine.” An agricultural machine performs agricultural work on the ground in a field, such as tilling, seeding, pest control, fertilizing, planting crops, or harvesting.

An example of the basic configuration and operation of the work vehicle according to this disclosure will be described. The work vehicle described below includes a motor and a fuel cell power generation system (hereinafter referred to as “FC power generation system”) that is configured to generate the power necessary to drive the motor.

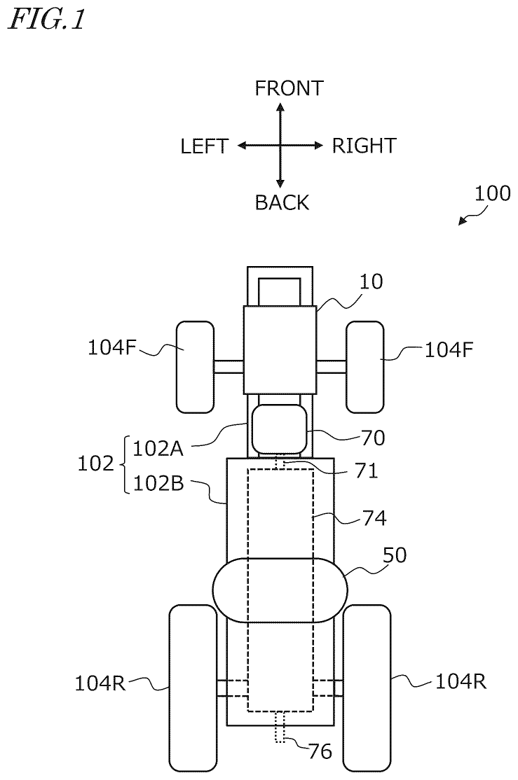

FIG. 1 is a plan view schematically showing an example of the basic configuration of a work vehicle 100 according to the present disclosure. In this disclosure, the direction in which the work vehicle 100 travels straight forward is referred to as the “forward direction,” and the direction in which it travels straight backward is referred to as the “backward direction.” In a plane parallel to the ground, the direction extending perpendicularly to the right of the “forward direction” is referred to as the “right direction,” and the direction extending perpendicularly to the left is referred to as the “left direction.” In FIG. 1, the “forward direction,” “backward direction,” “right direction,” and “left direction” are indicated by arrows labeled “front,” “back,” “right,” and “left” respectively. Both the forward and backward directions may be collectively referred to as the “front-back direction”.

The work vehicle 100 illustrated in this example is, for instance, a tractor, which defines and functions as an example of agricultural machinery. The technologies and example embodiments disclosed herein are not limited to work vehicles such as tractors and may be applied to other types of work vehicles. The work vehicle 100 is configured to attach or tow an implement and travel within a field while performing agricultural tasks appropriate to the type of implement. Additionally, the work vehicle 100 is configured to travel both within and outside the field (including on roads) with the implement raised or without an implement attached.

The work vehicle 100, like a conventional tractor, includes a vehicle frame 102 that rotatably supports left and right front wheels 104F and left and right rear wheels 104R. The vehicle frame 102 includes a front frame 102A, where the front wheels 104F are mounted, and a transmission case 102B, where the rear wheels 104R are mounted. The front frame 102A is fixed to the front portion of the transmission case 102B. The front wheels 104F and rear wheels 104R may be collectively referred to as wheels 104. Strictly speaking, the wheels 104 refer to wheel rims with tires attached. In this disclosure, the term “wheel” generally refers to the entire assembly of the “wheel rim and tire.” Either or both of the front wheels 104F and rear wheels 104R may be replaced with a plurality of wheels (crawlers) fitted with endless tracks instead of wheeled tires.

In the example shown in FIG. 1, the work vehicle 100 includes a fuel cell module (FC module) 10 and a motor 70, which are directly or indirectly supported by the front frame 102A. The FC module 10 includes a fuel cell stack (FC stack) and functions as an onboard power generator that generates electricity from fuel, as will be described later. Hereinafter, the terms “FC module” or “FC stack” may simply be referred to as “fuel cell.”

The motor 70 is electrically connected to the FC module 10. The motor 70 converts the electric power generated by the FC module 10 into mechanical motion (power) to produce the driving force (traction) necessary for the work vehicle 100 to travel. An example of the motor 70 is an AC synchronous motor. Since the FC stack of the FC module 10 generates direct current, when the motor 70 is an AC synchronous motor, a group of electrical circuits, including an inverter device, is installed between the FC stack and the motor 70 to convert the direct current to alternating current. A portion of such electrical circuit group may be inside the FC module 10, while another portion of the electrical circuit group may be attached to the motor 70 as a motor drive circuit.

The motor 70 includes an output shaft 71 that rotates. The torque of the output shaft 71 is transmitted to the rear wheels 104R through mechanical components such as transmission (gearbox) and a rear wheel differential gear device installed inside the transmission case 102B. In other words, the power generated by the motor 70, which serves as the power source, is transmitted to the rear wheels 104R through a power transmission system (drivetrain) 74 including the transmission installed in the transmission case 102B. For this reason, the “transmission case” may also be referred to as a “mission case.” In four-wheel drive mode, a portion of the power of the motor 70 is also transmitted to the front wheels 104F. The power of the motor 70 may be used not only to drive the work vehicle 100 but also to operate implements. Specifically, a power take-off (PTO) shaft 76 is provided at the rear end of the transmission case 102B. The PTO shaft 76 is driven by the motor 70 and implements is configured to be connected to. The torque from the output shaft 71 of the motor 70 is transmitted to the PTO shaft 76. Implements attached to or towed by the work vehicle 100 are configured to receive power from the PTO shaft 76 to perform various work-related operations. The motor 70 and the power transmission system 74 may collectively be referred to as an electric powertrain.

Thus, the work vehicle 100 disclosed herein does not include an internal combustion engine such as a diesel engine, but includes the FC module 10 and the motor 70. Additionally, the output shaft 71 of the motor 70 is mechanically coupled to the power transmission system 74, including the transmission in the transmission case 102B. The motor 70 efficiently generates torque over a relatively wide range of rotational speeds compared to an internal combustion engine. However, by utilizing the power transmission system 74, including the transmission, it becomes easier to adjust the torque and rotational speed from the motor 70 over an even wider range by performing multi-stage or continuously variable speed change operations. This configuration allows for efficient execution of not only the travel of the work vehicle 100 but also various operations using implements.

Depending on the application or size of the work vehicle 100, some functions of the power transmission system 74 may be omitted. For example, a portion or an entirety of the transmission responsible for speed change functions may be omitted. The number and mounting position of motors 70 are also not limited to the example shown in FIG. 1.

The work vehicle 100 includes at least one fuel tank 50 that stores fuel to be supplied to the FC module 10. For simplicity, FIG. 1 shows one fuel tank 50. In some example embodiments, a plurality of fuel tanks 50 may be housed in a tank case to define a fuel tank module. The fuel tank 50 is supported by structural elements fixed to the vehicle frame 102A described later. The FC module 10 and the fuel tank 50 are connected by piping and open/close valves, and similar components, defining an FC power generation system mounted on a vehicle. The configuration and operation of the FC power generation system will be described later.

The work vehicle 100 in the example embodiments described later includes a seat for a driver, hereinafter referred to as “a driver seat,” supported by the vehicle frame 102. The driver seat may be enclosed by a cabin supported by the vehicle frame 102. In the example embodiments described later, the FC module 10 is positioned in front of the driver seat, and the fuel tank 50 is positioned above the driver seat. Such FC module 10 and fuel tank 50 are housed in at least one “enclosure.” The “enclosure” functions as a housing, for example, and plays a role in protecting the FC module 10 and fuel tank 50 from sunlight exposure and wind and rain. Additionally, such an enclosure is designed to control the spread of fuel gas into the atmosphere and to facilitate the detection of fuel gas when fuel gas leaks from the FC module 10 or fuel tank 50.

The FC module 10 may be housed in a front housing called a “bonnet,” for example. The front housing is a portion of the “enclosure.” The front housing is supported by the front portion of the vehicle frame 102 (front frame 102A). The fuel tank 50 is housed in a tank case, as mentioned earlier. The tank case is directly or indirectly supported by the vehicle frame 102.

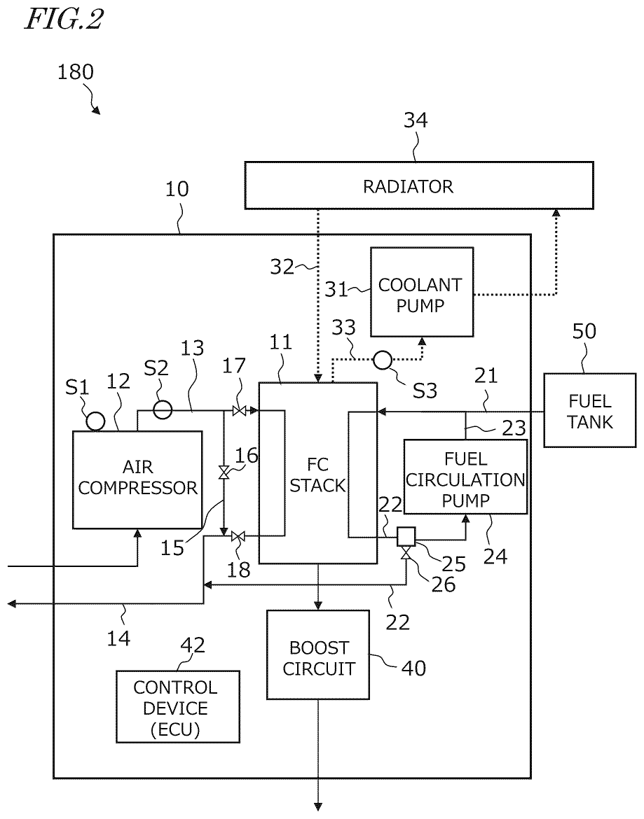

Next, referring to FIG. 2, a basic configuration example of the FC power generation system 180 mounted on the work vehicle 100 will be explained.

The FC power generation system 180 shown in FIG. 2 functions as an onboard power generation system in the work vehicle 100 of FIG. 1. The electric power generated by the FC power generation system 180 is used not only for the travel of the work vehicle 100 but also for the operation of implements towed or attached to the work vehicle 100.

The FC power generation system 180 in the illustrated example includes the FC module 10 and at least one fuel tank 50 that stores fuel to be supplied to the FC module 10. The FC power generation system 180 also includes a radiator 34 to cool the FC module 10.

The FC module 10 includes main components such as a fuel cell stack (FC stack) 11, an air compressor 12, a fuel circulation pump 24, a coolant pump 31, a boost circuit 40, and a controller 42. These components are housed within the casing of the FC module 10 and are connected to each other through electrical or fluid communication.

The FC stack 11 generates electric power through an electrochemical reaction between the fuel, referred to as “anode gas” and the oxidizing gas, referred to as “cathode gas.” In this example, the FC stack 11 includes polymer electrolyte fuel cells. The FC stack 11 has a stack structure in which a plurality of single cells (fuel cell elements) are stacked. A single cell includes, for example, an electrolyte membrane that is an ion exchange membrane, an anode electrode on one side of the electrolyte membrane, a cathode electrode on the other side of the electrolyte membrane, and a pair of separators sandwiching the anode electrode and cathode electrode on both sides. The voltage generated in a single cell is, for example, less than 1 volt. Therefore, in the FC stack 11, for instance, more than 300 single cells are connected in series to generate a voltage of several hundred volts.

Anode gas is supplied to the anode electrode of the FC stack 11. The anode gas is called “fuel gas” or simply “fuel.” In the example embodiments of this disclosure, the anode gas (fuel) is hydrogen gas. Cathode gas is supplied to the cathode electrode. The cathode gas is an oxidizing gas such as air. The anode electrode is called the fuel electrode, and the cathode electrode is called the air electrode.

At the anode electrode, the electrochemical reaction shown in the following equation (1) occurs.

2H₂→4H⁺+4e⁻ equation (1)

At the cathode electrode, the electrochemical reaction shown in the following equation (2) occurs.

4H⁺+4e⁻+O₂→2H₂O equation (2)

Overall, the reaction shown in the following equation (3) occurs.

2H₂+O₂→2H₂O equation (3)

The anode gas after being used in the above reaction is called “anode off-gas”, and the cathode gas after being used in the reaction is called “cathode off-gas.”

The air compressor 12 supplies air taken from the outside as cathode gas to the cathode electrode of the FC stack 11. The cathode gas supply system including the air compressor 12 includes a cathode gas supply pipe 13, a cathode off-gas pipe 14, and a bypass pipe 15. The cathode gas supply pipe 13 flows cathode gas (air) supplied from the air compressor 12 to the cathode electrode of the FC stack 11. The cathode off-gas pipe 14 flows cathode off-gas discharged from the FC stack 11 to the outside air. The bypass pipe 15 branches from the cathode gas supply pipe 13 downstream of the air compressor 12, bypasses the FC stack 11, and connects to the cathode off-gas pipe 14. A control valve 16 is provided on the bypass pipe 15 to adjust the flow rate of cathode gas flowing through the bypass pipe 15. A shut-off valve 17 is provided on the cathode gas supply pipe 13 to selectively block the inflow of cathode gas to the FC stack 11. A pressure regulating valve 18 is provided on the cathode off-gas pipe 14 to adjust the back pressure of the cathode gas.

The cathode gas supply system of the FC module 10 includes a rotation speed detection sensor S1 that detects the rotation speed of the air compressor 12 and a gas flow rate detection sensor S2 that detects the flow rate of cathode gas flowing through the cathode gas supply pipe 13. The control valve 16, shut-off valve 17, and pressure regulating valve 18 are, for example, electromagnetic valves.

The fuel circulation pump 24 supplies fuel gas (anode gas) sent from the fuel tank 50 to the anode electrode of the FC stack 11. The anode gas supply system including the fuel circulation pump 24 includes an anode gas supply pipe 21, an anode off-gas pipe 22, and a circulation path 23. The anode gas supply pipe 21 flows anode gas supplied from the fuel tank 50 to the anode electrode of the FC stack 11. In the example embodiments of this disclosure, the fuel tank 50 is a hydrogen tank that stores high-pressure hydrogen gas.

The anode off-gas pipe 22 flows anode off-gas discharged from the FC stack 11. The anode off-gas is led through the anode off-gas pipe 22 to a gas-liquid separator 25 in which moisture is removed. The anode off-gas with moisture removed returns to the anode gas supply pipe 21 through the circulation path 23 by the fuel circulation pump 24. The anode off-gas circulating through the circulation path 23 can be discharged through the anode off-gas pipe 22 by opening an exhaust valve 26. Moisture accumulated in the gas-liquid separator 25 can be discharged through the anode off-gas pipe 22 by opening the exhaust valve 26. The exhaust valve 26 is, for example, an electromagnetic valve. In the example shown in the figure, the anode off-gas pipe 22 is connected to the cathode off-gas pipe 14. By adopting this configuration, it is possible to improve the utilization efficiency of the anode gas by circulating the anode off-gas containing unreacted anode gas that did not contribute to the electrochemical reaction and supplying it again to the FC stack 11.

To enhance the performance of the FC stack 11, temperature control is important. When generating electricity through the reaction of producing water from hydrogen gas and oxygen gas, heat is also generated, necessitating cooling. FIG. 2 shows a coolant circulation system including a coolant pump 31 for the FC stack 11, but as described later, cooling circulation systems for other electrical equipment may also be provided. Note that the air compressor 12, fuel circulation pump 24, and coolant pump 31 included in the FC module 10 are driven by individual built-in motors. These motors are also electrical equipment.

The coolant circulation system including the coolant pump 31 shown in FIG. 2 includes a coolant supply pipe 32, a coolant discharge pipe 33, a radiator device 34, and a temperature sensor S3. This coolant circulation system is configured to adjust the temperature of the FC stack 11 within a predetermined range by circulating coolant through the FC stack 11. The coolant is supplied to the FC stack 11 through the coolant supply pipe 32. The supplied coolant flows through a coolant path between single cells and is discharged into the coolant discharge pipe 33. The coolant discharged into the coolant discharge pipe 33 flows to the radiator device 34. The radiator device 34 performs heat exchange between the incoming coolant and the outside air to release heat from the coolant, and then resupplies the cooled coolant to the coolant supply pipe 32.

The coolant pump 31 is provided on either the coolant supply pipe 32 or the coolant discharge pipe 33 to pump coolant to the FC stack 11. A coolant bypass flow path may be provided between the coolant discharge pipe 33 and the coolant supply pipe 32. In that case, a flow dividing valve is provided at the branching point at which the coolant bypass flow path branches from the coolant discharge pipe 33. The flow dividing valve is configured to adjust the flow rate of coolant flowing through the bypass flow path. The temperature sensor S3 detects the temperature of the coolant flowing through the coolant discharge pipe 33.

The coolant used to cool the FC stack 11 is circulated through the flow path by an electric coolant pump 31. A coolant control valve may be provided downstream of the FC stack 11. The coolant control valve adjusts the ratio of coolant flowing to the radiator device 34 and coolant bypassing the radiator device 34, enabling more accurate control of the coolant temperature. Furthermore, by controlling the liquid delivery amount by the coolant pump, it is also possible to control the coolant temperature difference between the inlet and outlet of the FC stack 11 to be within a desired range. The temperature of the coolant in the FC stack 11 may be controlled to be around 70° C., for example, which is a temperature where the power generation efficiency of the FC stack 11 is high.

The coolant flowing through the FC stack 11 preferably has higher insulation properties compared to the coolant used to cool ordinary electrical equipment. Since voltages exceeding 300 volts can occur in the FC stack 11, increasing the electrical resistance of the coolant allows for the reduction or prevention of current leakage through the coolant or devices such as the radiator device 34. The electrical resistance of the coolant may decrease as the coolant is used. This is because ions dissolve into the coolant flowing through the FC stack 11. To remove such ions from the coolant and increase insulation property, it is desirable to place an ion exchanger in the coolant flow path.

The boost circuit 40 is configured to increase the voltage output by the FC stack 11 through power generation to a desired level. The subsequent stage of the boost circuit 40 is connected to the high-voltage electrical circuit including an inverter device for motor drive. Additionally, the subsequent stage of the boost circuit 40 may also be connected in parallel to the low-voltage electrical circuit via a step-down circuit.

The controller 42 may include an electronic control unit (ECU) configured or programmed to control power generation by the FC module 10. The controller 42 is configured or programmed to detect or estimates the operating state of the FC power generation system 180 based on signals output from various sensors. The controller 42 is configured or programmed to control power generation by the FC stack 11 by regulating the operation of the air compressor 12, fuel circulation pump 24, coolant pump 31, and various valves, based on the operating state of the FC power generation system 180 and instructions output from a primary computer or other ECUs. The controller 42 includes, for example, a processor, a storage, and an input/output interface.

In the following description, for simplicity, “anode gas” may be referred to as “fuel gas” or “fuel,” and “anode gas supply pipe” may be referred to as “piping.”

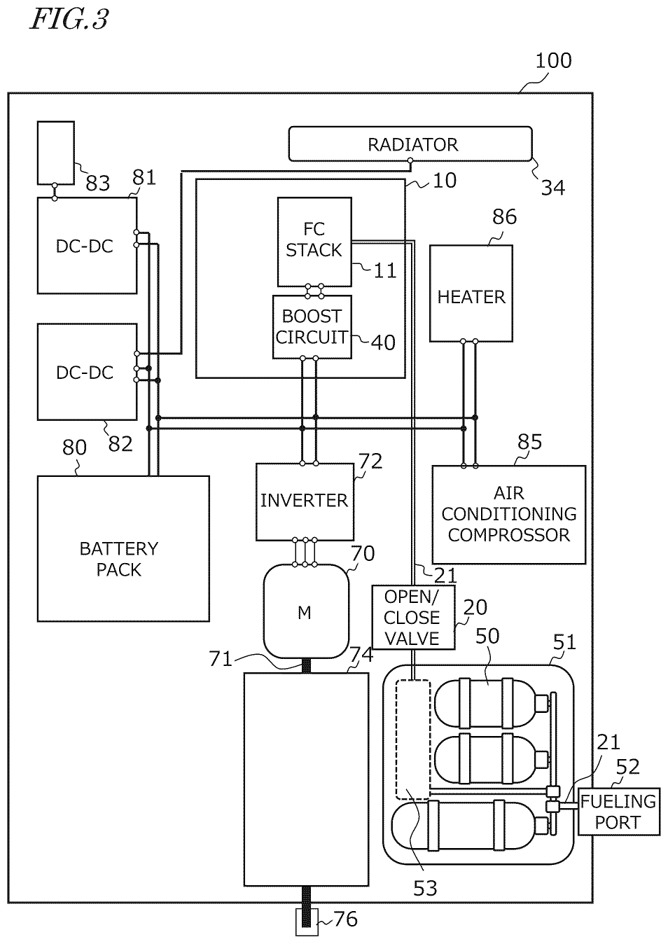

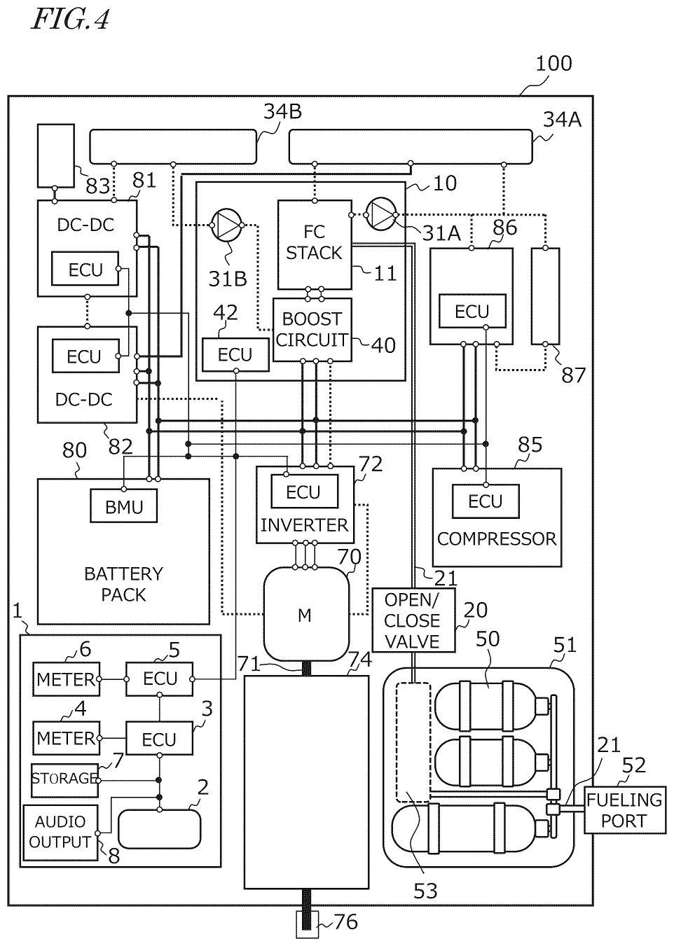

Next, referring to FIG. 3 and FIG. 4, a configuration example of the system of the work vehicle 100 according to this disclosure will be described. FIG. 3 is a block diagram schematically showing an example of electrical connections and power transmission between components of the work vehicle 100 according to this disclosure. FIG. 4 is a block diagram showing a more detailed configuration than the example in FIG. 3. FIG. 4 schematically shows the paths of electrical signals (thin solid lines) and coolant (dotted lines) between components in the work vehicle 100.

First, referring to FIG. 3, an example of the electrical connections and power transmission between components will be described. Electrical connections include both high-voltage and low-voltage systems. High-voltage electrical connections provide, for example, the power supply voltage for inverter devices. Low-voltage electrical connections provide, for example, the power supply voltage for electronic components that operate at relatively low voltages.

In the example shown in FIG. 3, the work vehicle 100 includes an FC module 10, an inverter device 72, a motor 70, a power transmission system 74, and a PTO shaft 76. The DC voltage of the power generated in the FC stack 11 of the FC module 10 is boosted by the boost circuit 40 and then supplied to the inverter device 72. The inverter device 72 converts the DC voltage into, for example, a three-phase AC voltage and supplies it to the motor 70. The inverter device 72 includes a bridge circuit including a plurality of power transistors. The motor 70 includes a rotating rotor and a stator with a plurality of coils electrically connected to the inverter device 72. The rotor is coupled to the output shaft 71, for example, via a reduction gear (speed reducer) or directly. The motor 70 rotates the output shaft 71 with torque and rotational speed controlled according to the waveform of the three-phase AC voltage from the inverter device 72.

The torque of the output shaft 71 of the motor 70 is transmitted to the power transmission system 74. The power transmission system 74 operates with the motor 70 as the power source and drives the wheels 104R and 104F, and/or the PTO shaft 76 shown in FIG. 1. This power transmission system 74 may have the same or similar structure as the power transmission system in conventional tractors including internal combustion engines such as diesel engines. By adopting a power transmission system used in agricultural tractors, for example, it is possible to reduce the design and manufacturing costs for producing an agricultural work vehicle 100 including an FC power generation system. The power transmission system 74 includes a travel power transmission mechanism that transmits power from the motor 70 to the left and right rear wheels 104R through a clutch, transmission, and rear wheel differential device, and a PTO power transmission mechanism that transmits power from the motor 70 to the PTO shaft 76. The power transmission system 74 includes a PTO clutch that switches between a state (connected state) in which power from the motor 70 is transmitted to the PTO shaft 76 and a state (disconnected state) in which it is not transmitted. The PTO clutch may be manually operated by the driver through the operation of an operating portion such as a clutch pedal. The PTO clutch may also be automatically disconnected by control or other means. The transmission case 102B in FIG. 1 may be divided into a front case (mission case) housing clutches such as the PTO clutch and transmission, and a rear case (differential gear case) housing the rear wheel differential device. The rear case may also be referred to as a rear axle case.

The work vehicle 100 includes a secondary battery (battery pack) 80 that temporarily stores electrical energy generated by the FC module 10. An example of the battery pack 80 includes a pack of lithium-ion batteries. The battery pack 80 is configured to supply power to the inverter device 72 at the necessary timing in cooperation with the FC module 10 or independently. Various battery packs used in electric passenger vehicles may be adopted as the battery pack 80.

The work vehicle 100 includes various electrical equipment (onboard electronic components) that operates on electricity, in addition to the motor 70 and the inverter device 72. Examples of electrical equipment include electromagnetic valves such as open/close valves 20, air cooling fans of the radiator device 34, electric pumps of air conditioning compressors 85, and temperature controllers configured or programmed to heat or cool the FC stack 11. The temperature controllers include electric heaters 86. First and second DC-DC converters 81 and 82 to obtain appropriate power supply voltages for the operation of electrical equipment, and storage batteries 83 may also be included in the electrical equipment. Furthermore, various electronic components not shown (such as lamps, electric motors for hydraulic systems) may be included in the electrical equipment. The electrical equipment may be electronic components similar to electrical equipment installed in conventional agricultural tractors.

In the example of FIG. 3, the first DC-DC converter 81 is a circuit that steps down the voltage output from the boost circuit 40 of the FC module 10 to a first voltage, for example, 12 volts. The storage battery 83 is, for example, a lead-acid battery and stores electrical energy at the voltage output from the first DC-DC converter 81. The storage battery 83 may be used as a power source for various electrical equipment such as lamps.

The work vehicle 100 shown in FIG. 3 includes not only the first DC-DC converter 81 but also a second DC-DC converter 82 as a voltage conversion circuit that steps down the high voltage output by the FC module 10. The second DC-DC converter 82 is a circuit that steps down the voltage output from the boost circuit 40 of the FC module 10 (for example, several hundred volts) to a second voltage higher than the first voltage, for example, 24 volts. The air cooling fan of the radiator device 34, for example, is configured to operate on the voltage output from the second DC-DC converter 82. Note that although the radiator device 34 is described as a single component in FIG. 3, one work vehicle 100 may include a plurality of radiator devices 34. Additionally, the electric pump of the air conditioning compressor 85 and the electric heater 86 are configured to operate on the voltage output from the second DC-DC converter 82.

The work vehicle 100 shown in FIG. 3 includes a temperature controller that cools or heats the FC stack 11 included in the FC power generation system. The operation of the temperature controller or alike requires relatively large power. The relatively high 24-volt voltage output by the second DC-DC converter 82 is applied to the temperature controller. In this example embodiment, the temperature controller includes the radiator device 34 that releases heat from the coolant cooling the FC stack 11, and the relatively high 24-volt voltage (second voltage) output by the second DC-DC converter 82 is applied to the radiator device 34. The temperature controller includes a heater 86 that heats the FC stack 11. The relatively high voltage output by the second DC-DC converter 82 may also be applied to the heater. The relatively high voltage output by the second DC-DC converter 82 may also be applied to air conditioning devices such as the air conditioning compressor 85.

The work vehicle 100 may include a third voltage conversion circuit that converts the high voltage output by the FC module 10 to a third voltage higher than the second voltage. The third voltage is, for example, 48 volts. If the work vehicle 100 includes another motor in addition to the motor 70, for example, the third voltage may be used as the power source for such other motors.

In an agricultural work vehicle including a fuel cell power generation system, in addition to the electrical equipment necessary for agricultural task, the agricultural work vehicle also includes electrical equipment necessary for the operation of fuel cell power generation, so the appropriate voltage magnitude may differ for each electrical equipment. According to the example embodiments of this disclosure, it is possible to supply voltages of appropriate magnitudes.

In the example shown in FIG. 3, a plurality of fuel tanks 50 are housed in a single tank case 51. The fuel tank 50 is connected to a supplying port (fueling port) 52 through which fuel is supplied from the outside. This connection is made via piping 21 to flow fuel gas. The fuel tank 50 is also connected to the FC module 10 via piping 21, which is equipped with an open/close valve 20. When hydrogen is used as the fuel gas, the piping 21 may be formed from materials with high resistance to hydrogen embrittlement, such as austenitic stainless steel like SUS316L.

A valve space 53 is provided in the tank case 51, and various valves including a pressure reducing valve are provided in the valve space 53. Through various valves provided in the valve space 53, the piping 21 connects the fuel tank 50 and the FC module 10. Fuel gas with reduced pressure by the pressure reducing valve flows through the piping 21 connecting the tank case 51 and the FC module 10. When the fuel gas is hydrogen gas, high-pressure hydrogen gas of, for example, 35 megapascals or more may be filled in the fuel tank 50, but the hydrogen gas after passing through the pressure reducing valve may be reduced to about 2 atmospheres or less.

The fuel tank 50 is equipped with a sensor S4 to measure the remaining amount of fuel in the fuel tank 50. Additionally, a temperature sensor may be provided to measure the temperature inside the fuel tank 50. Examples of sensor S4 include a pressure sensor that measures the pressure of the fuel corresponding to the remaining amount of fuel. The pressure sensor acquires residual pressure data indicating the residual pressure of the fuel remaining in the fuel tank 50.

As mentioned above, the first and second DC-DC converters 81 and 82 are configured to output voltages of different magnitudes. ECUs are also provided for these first and second DC-DC converters 81 and 82 to control each voltage conversion circuit. The relatively low first voltage which the first DC-DC converter 81 outputs is applied to these ECUs, like other ECUs.

In the example of FIG. 4, the work vehicle 100 includes a cooling system in which coolant circulates via coolant pumps 31A and 31B. These coolant pumps 31A and 31B are provided inside the FC module 10. The cooling system in this example includes a first radiator device 34A responsible for cooling the FC stack 11 and a second radiator device 34B to cool other electrical equipment. The cooling system includes a flow path (first flow path) where coolant flows between the FC stack 11 and the first radiator device 34A. Furthermore, this cooling system includes a flow path (second flow path) where coolant flows between electrical equipment including the motor 70 and the second radiator device 34B. In the example of FIG. 4, for instance, a heater core 87 used to heat the cabin is provided, and the coolant flowing through the first radiator device 34A flows through the heater core 87.

The user interface 1 includes an operation device 2 such as an accelerator pedal (or accelerator lever) and a main ECU 3 connected to the operation device 2. The main ECU 3 is connected to a main meter 4. The main meter 4 may display various parameters that identify the travel state or operating state of the work vehicle 100. The user interface 1 further includes an FC system ECU 5 configured or programmed to control the FC power generation system. The FC system ECU 5 is connected to an FC meter 6. The FC meter 6 may display various parameters that identify the operating state of the FC power generation system.

The user interface 1 includes an operation device 2 such as an accelerator pedal (or accelerator lever) and a main ECU 3 connected to the operation device 2. The main ECU 3 is connected to a main meter 4, a storage 7, an audio output 8, and other components. The main meter 4 may display various parameters that identify the travel state or operating state of the work vehicle 100. The user interface 1 further includes an FC system ECU 5 to control the FC power generation system. The FC system ECU 5 is connected to an FC meter 6. The FC meter 6 may display various parameters that identify the operating state of the FC power generation system.

The storage 7 includes one or more storage media such as flash memory or magnetic disks. The storage 7 stores various data generated by the main ECU 3 and FC system ECU 5. The storage 7 also stores computer programs that cause the main ECU 3 and FC system ECU 5 to perform desired operations. The computer programs may be provided to the work vehicle 100 via storage media (e.g., semiconductor memory or optical discs) or telecommunication lines (e.g., the Internet). The computer programs may be sold as commercial software.

The user interface 1 may further include an audio output 8. Examples of the audio output 8 include a buzzer or a speaker. The audio output 8 may be controlled by the main ECU 3. For example, the audio output 8 outputs audio prompting refueling as described later.

The cells of the battery pack 80 are controlled by a Battery Management Unit (BMU). The BMU includes circuits and a CPU (Central Processing Unit) that perform voltage monitoring for each cell of the battery, monitoring of overcharging and over-discharging, and cell balance control. These circuits and CPU may be mounted on a battery controller board.

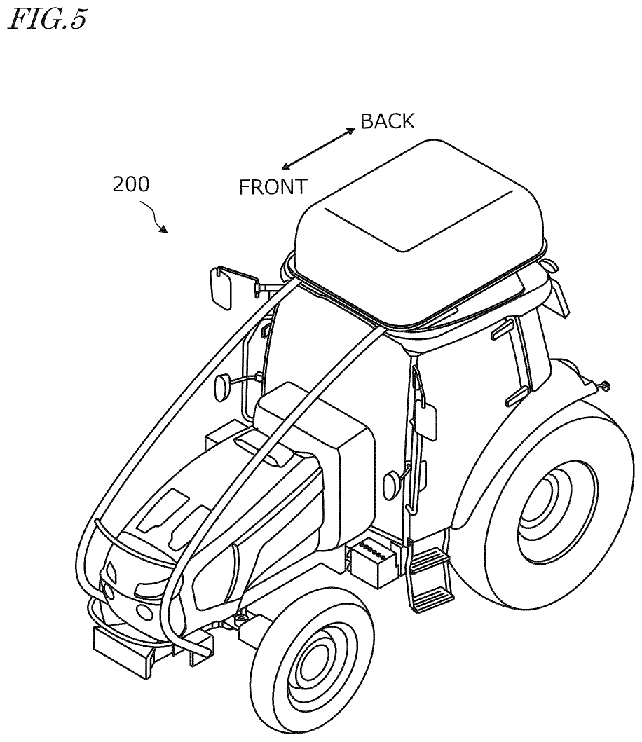

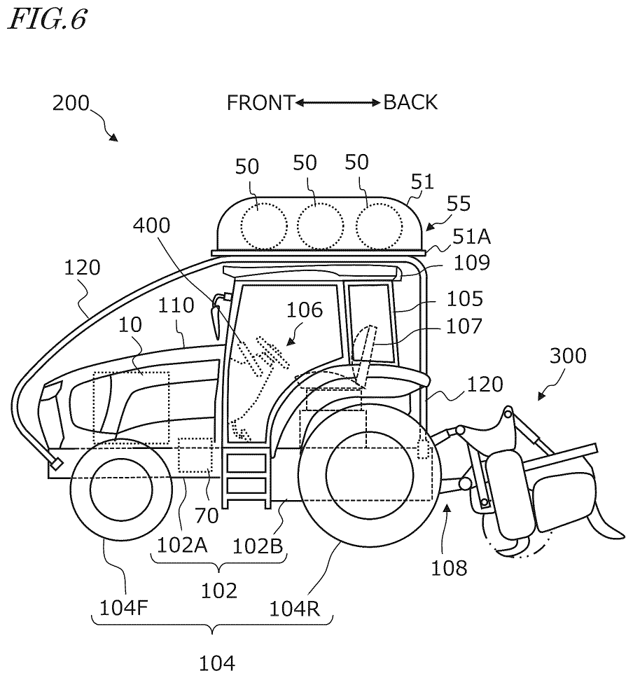

Next, referring to FIG. 5 and FIG. 6, a basic configuration of an example embodiment of the work vehicle according to the present disclosure will be described. FIG. 5 is a perspective view schematically showing an example of the configuration of the work vehicle 200 in this example embodiment.

FIG. 6 is a side view schematically showing an example of the configuration of the work vehicle 200 in this example embodiment.

The work vehicle 200 in this example embodiment includes an FC module 10, a fuel tank 50, a sensor S4 (refer to FIG. 3 or FIG. 4), a motor 70, a driver seat 107, and a vehicle frame 102. The work vehicle 200 has a configuration similar to the configuration of the work vehicle 100 explained with reference to FIG. 1.

The work vehicle 200 in this example embodiment further includes a display, a processor, and an operation terminal 400. For example, the main meter 4 and/or the FC meter 6, or the operation terminal 400 may function as the display. The main ECU 3, a primary computer that communicates with the main ECU 3, or a combination of these may function as the processor.

The operation terminal 400 is a terminal for the user to execute operations related to the travel of the work vehicle and the operation of the implement, and is also referred to as a virtual terminal (VT). The operation terminal 400 may include a touch screen type display and/or one or more buttons. The display may be, for example, a display such as a liquid crystal or organic light-emitting diode (OLED). By operating the touch screen of the operation terminal 400, the user may perform various operations such as inputting information related to the type of implement 300 and/or the type of work, altering control values for the work vehicle 200 such as vehicle speed or engine speed, and switching the implement on/off. The operation terminal 400 may be configured to be detachable from the work vehicle 200. A user at a location away from the work vehicle 200 may operate the detached operation terminal 400 to control the operation of the work vehicle 200.

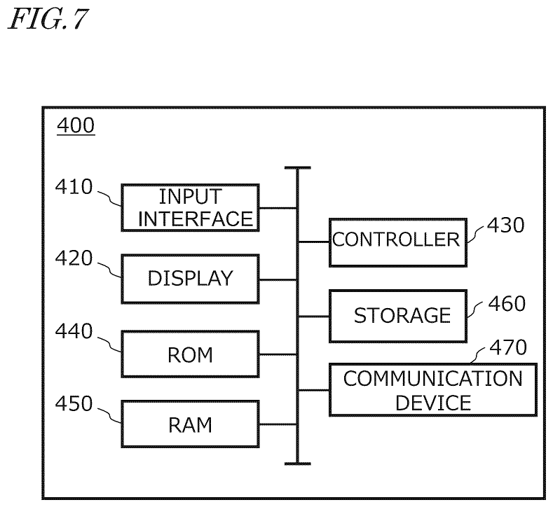

FIG. 7 is a block diagram exemplifying the hardware configuration of the operation terminal 400. The operation terminal 400 shown in FIG. 7 includes an input interface 410, a display 420, a controller 430, a ROM 440, a RAM 450, a storage 460, and a communication device 470. These components are communicably connected to each other via a bus.

The input interface 410 is a device to convert instructions from the user into data and to input it into the computer. The display 420 may be, for example, a liquid crystal display or an organic EL display. The display 420 includes a touch screen and, in addition to the function of displaying images, also serves as the input interface 410.

The controller 430 may include a processor. The processor may be a semiconductor integrated circuit including, for example, a central processing unit (CPU). The processor may be achieved by a microprocessor or a microcontroller. Alternatively, the processor may also be realized by an FPGA (Field Programmable Gate Array) with a CPU, a GPU (Graphics Processing Unit), an ASIC (Application Specific Integrated Circuit), an ASSP (Application Specific Standard Product), or a combination of two or more circuits selected from these circuits. The processor sequentially executes a computer program describing a group of instructions to execute at least one process stored in the ROM 440 to realize the desired processing.

The ROM 440 is, for example, a writable memory (e.g., PROM), a rewritable memory (e.g., flash memory), or a read-only memory. The ROM 440 stores programs that control the operation of the processor. The ROM 440 does not need to be a single storage medium, but may be an aggregate of a plurality of storage media. A portion of the aggregate of a plurality of storage media may be removable memory.

The RAM 450 provides a work area for temporarily expanding the control program stored in the ROM 440 at boot time. The RAM 450 does not need to be a single storage medium, but may be an aggregate of a plurality of storage media.

The storage 460 may be, for example, a magnetic storage or a semiconductor storage. An example of a magnetic storage is a hard disk drive (HDD). An example of a semiconductor storage is a solid-state drive (SSD).

The communication device 470 is a communication module to communicate, for example, with a cloud server that manages agricultural work, a work vehicle, or a terminal device that may be used by a user (such as a farm manager or agricultural worker) via a network. The communication device 470 can perform wired communication compliant with communication standards such as IEEE1394 (registered trademark) or Ethernet (registered trademark), for example. The communication device 470 may perform wireless communication compliant with Bluetooth (registered trademark) or Wi-Fi standards, or cellular mobile communication such as 3G, 4G, or 5G.

The work vehicle 200 may further include at least one sensing device that senses the environment around the work vehicle 200, and a processor that processes sensor data output from the at least one sensing device. The sensing device may include, for example, a plurality of cameras, a LiDAR sensor, and a plurality of obstacle sensors. The sensor data output from the sensing device may be used for positioning, for example. Various ECUs mounted on the work vehicle 200 may collaborate to perform calculations and control for realizing autonomous driving based on the sensor data output from the sensing device.

In this example embodiment, the fuel tank 50 is supported by a mounting frame 120. The mounting frame 120 is fixed to the vehicle frame 102 straddling the driver seat 107. The fuel tank 50 is located above the driver seat 107. However, the installation location of the fuel tank 50 is not limited to the illustrated example and may be, for example, inside the front housing 110.

In this example embodiment, the mounting frame 120 is an elongated structure such as a pipe fixed to the vehicle frame 102. The mounting frame 120 includes two frames positioned on the left and right sides of the work vehicle 200 (refer to FIG. 5). The front portion of the mounting frame 120 has a curved shape. Note that the shape of the mounting frame 120 shown is just an example, and the shape of the mounting frame 120 is not limited to this example.

In this example embodiment, the vehicle frame 102 includes a front frame 102A that rotatably supports the front wheels 104F, and a transmission case 102B that rotatably supports the rear wheels 104R. One end (front end) of the mounting frame 120 is fixed to the front frame 102A. The other end (rear end) of the mounting frame 120 is fixed to the transmission case 102B. These fixations may be made by appropriate methods such as welding or bolt joining, depending on the material of the mounting frame 120. The mounting frame 120 may be formed from metal, synthetic resin, carbon fiber, or composite materials such as carbon fiber reinforced plastic or glass fiber reinforced plastic. The transmission case 102B includes a rear axle case, and the rear end of the mounting frame 120 may be fixed to the rear axle case. When the mounting frame 120 is formed from metal, a portion or entirety of its surface may be covered with synthetic resin.

As shown in FIG. 6, the work vehicle 200 includes a cabin 105 that surrounds the driver seat 107 between the vehicle frame 102 and the mounting frame 120. The driver seat 107 is located in the rear portion of the interior of the cabin 105. In front of the driver seat 107, for example, a steering wheel 106 for changing the direction of the front wheels 104F, and an operation terminal 400 are provided. The cabin 105 includes a cabin frame that forms its skeleton. A roof 109 is provided on the upper part of the cabin frame. The cabin frame in this example embodiment is a 4-pillar style. The cabin 105 is supported by the transmission case 102B of the vehicle frame 102, for example, via vibration-isolating mounts. The user interface 1 explained with reference to FIG. 4 is provided inside the cabin 105. Since the cabin 105 does not directly support the fuel tank 50, there is no need to specially increase its strength, and a cabin that has been used in conventional tractors can be adopted.

The work vehicle 200 includes a placement platform 51A that connects the left frame 120 and the right frame 120. The fuel tank 50 may be placed on the placement platform 51A. When there are a plurality of fuel tanks 50, the plurality of fuel tanks 50 may be provided in a fuel tank module 55. As shown in FIG. 6, the fuel tank module 55 includes a tank case 51 that houses a plurality of fuel tanks 50. The left and right mounting frames 120 may be connected to each other by structural elements other than the placement platform 51A.

A coupling device 108 is provided at the rear end of the transmission case 102B, which is the rear portion of the vehicle frame 102. The coupling device 108 includes, for example, a three-point support device (also referred to as a “three-point link” or “three-point hitch”), a PTO shaft, a universal joint, and a communication cable. The implement 300 may be attached to or detached from the work vehicle 200 using the coupling device 108. The coupling device 108 can, for example, raise and lower the three-point link by a hydraulic device to change the position or posture of the implement 300. Also, power can be transmitted from the work vehicle 200 to the implement 300 via the universal joint. The work vehicle 200 can execute predetermined work (agricultural task) with the implement 300 while pulling the implement 300. The coupling device 108 may be provided on the front portion of the vehicle frame 102. In that case, the implement 300 can be connected to the front of the work vehicle 200.

The implement 300 includes, for example, a drive device, a controller, and a communication device. The drive device performs the necessary actions for the implement 300 to execute predetermined work. The drive device includes, for example, a hydraulic device, an electric motor, or a pump, depending on the application of the implement 300. The controller is configured or programmed to control the operation of the drive device. The controller is configured or programmed to execute various operations of the drive device in response to signals transmitted from the work vehicle 200 via the communication device. It is also possible to transmit signals corresponding to the state of the implement 300 to the work vehicle 200 from the communication device.

The implement 300 shown in FIG. 6 is a rotary tiller, but the implement 300 is not limited to a rotary tiller. For example, any implement such as a seeder, a spreader (fertilizer applicator), a transplanter, a mower, a rake, a baler, a harvester, a sprayer, or a harrow can be connected to and used with the work vehicle 200.

The work vehicle 200 shown in FIG. 6 is capable of manned operation, but it may also be adapted for unmanned operation only. In that case, components necessary only for manned operation, such as the cabin 105, steering wheel 106, and driver seat 107, may not be provided on the work vehicle 200. The work vehicle 200 which is unmanned can travel by autonomous driving or remote control by the user.

The processor in this example embodiment is configured or programmed to estimate at least one of travelable distance, travelable area, and travelable time with work based on the remaining amount of fuel measured by the sensor S4 provided in the fuel tank 50, and the type of implement 300 connected to the PTO shaft 76 and/or the type of work performed by the implement 300, and to display the estimation results on the display.

The types of implements are, as described above, for example, rotary, seeder, or spreader. The types of work performed by the implement are, for example, tilling, seeding, or fertilizing. Note that the type of implement and the type of work do not necessarily correspond one-to-one. For example, when the type of implement is a rotary, the type of work may include a plurality of types such as tilling, puddling, or ridging.

The processor, for example, is configured or programmed to acquire identification information of the implement 300 from the implement 300 connected to the PTO shaft 76, and identifies the type of implement 300 based on the identification information. The work vehicle 200 and the implement 300 are configured to communicate in compliance with ISOBUS standards such as ISOBUS-TIM. In this manner, the processor of the work vehicle 200 may obtain the identification information of the implement 300 by communicating with the implement 300. Alternatively, the processor may identify the type of implement 300 connected to the PTO shaft 76 and/or the type of work performed by the implement 300 based on information about the type of implement 300 and/or the type of work input by the user, for example, via the input interface 410 of the operation terminal 400.

The sensor S4 obtains residual data of the fuel in the fuel tank 50. The processor is configured or programmed to estimate the remaining amount of fuel based on the residual pressure data output from the sensor S4. In this example embodiment, the remaining amount of fuel estimated in this manner may be referred to as the remaining amount of fuel measured by the sensor S4. The remaining amount of fuel may be expressed as a percentage (%) of the remaining amount relative to the tank capacity in a full state.

The storage 7 shown in FIG. 4 stores data indicating the relationship between the type of implement and/or the type of work, and the fuel consumption per unit time. The processor in this example embodiment estimates at least one of the travelable distance, travelable area, and travelable time with work based on this data. The unit of fuel consumption per unit time is, for example, L/h (liters/hour). Hereinafter, the fuel consumption per unit time is simply referred to as “fuel consumption”.

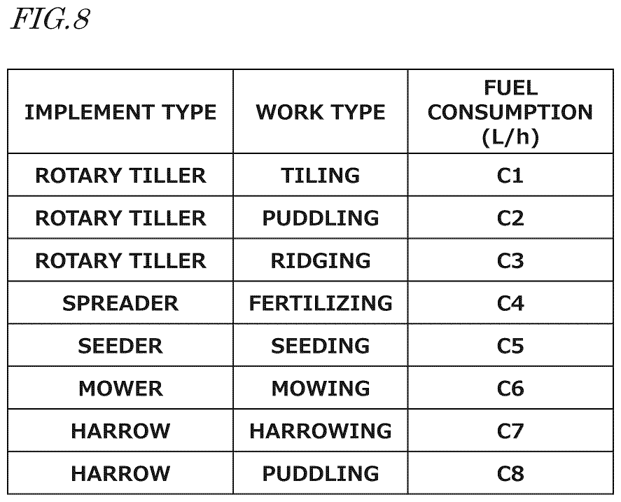

FIG. 8 is a diagram showing an example of a table showing the relationship between the type of implement, the type of work, and fuel consumption. In the example of the table (or lookup table) shown in FIG. 8, the types of implements include five types: rotary, spreader, seeder, mower, and harrow, and the types of work include seven types: tilling, puddling, ridging, fertilizing, seeding, mowing, and pulverizing. The table lists the corresponding fuel consumption for each combination of implement type and work type. For example, the fuel consumption when the work vehicle 200 is performing tilling work while towing a rotary is C1 L/h, and the fuel consumption when the work vehicle 200 is performing fertilizing work while towing a spreader is C4 L/h. The fuel consumption may differ depending on the type of implement. Additionally, even when the type of implement is the same, the fuel consumption may differ depending on the type of work.

The fuel consumption included in the example table means the combined fuel consumption of the work vehicle and the implement. However, the storage may store table data that individually associates the fuel consumption of the work vehicle and the fuel consumption of the implement with the type of implement and the type of work. In this case, the processor simply add up the respective fuel consumptions identified by referring to the table.

The processor is configured or programmed to identify the fuel consumption corresponding to the type of implement 300 and the type of work by referring to the table. The processor is configured or programmed to estimate the travelable time, travelable distance (e.g., km) with work based on the identified fuel consumption (L/h) and the amount of fuel remaining (L) measured by the sensor S4. For example, the processor is configured to calculate the time available for work by dividing the remaining amount of fuel by the fuel consumption. The processor may further calculate the travelable distance by multiplying the time available for work by the speed of the work vehicle 200. The identification information of the implement 300 may further include information such as the size in the width direction of the implement 300. The processor may calculate the area of the workable area in the field by multiplying the travelable distance by the size in the width direction of the implement 300. The processor is configured or programmed to display at least one of the distance, area, and time estimated in this manner on the display.

The storage 7 may store the fuel consumption C9 (L/h) when the implement 300 is not driven, that is, when the PTO is not driven. In this case, the processor may estimate the travelable time and distance (e.g., km) without work based on the fuel consumption C9 (L/h) and the remaining amount of fuel (L) measured by the sensor S4. It should be noted that the fuel consumption C9 (L/h) when the implement is not driven is smaller than the fuel consumption when the implement is driven (for example, any of C1 to C8 shown in FIG. 8).

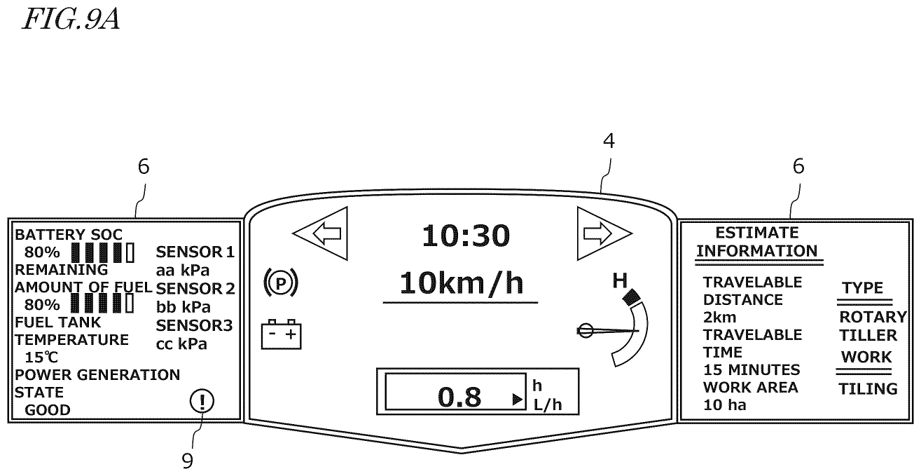

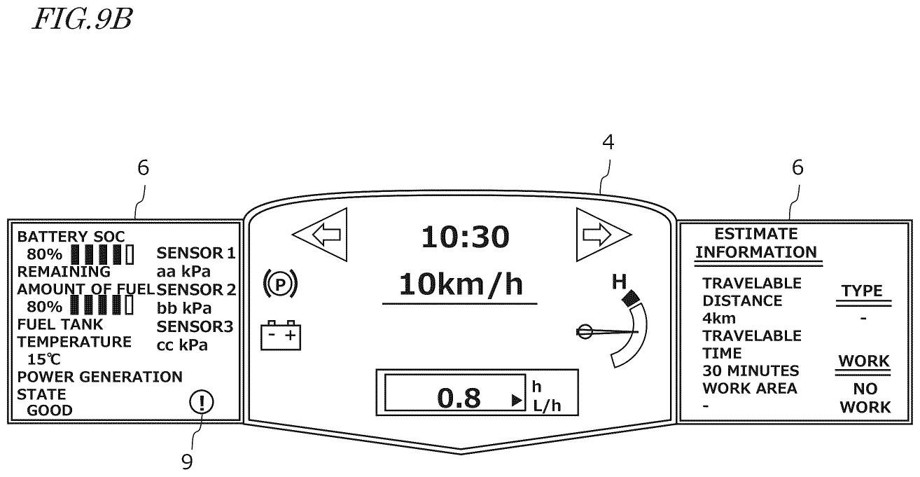

FIG. 9A is a diagram schematically showing an example of displaying estimation results on the display when the implement is driven. FIG. 9B is a diagram schematically showing an example of displaying estimation results on the display when the implement is not driven.

The displays exemplified in FIG. 9A and FIG. 9B are the main meter 4 and the FC meter 6. In this example, each of the main meter 4 and the FC meter 6 is a digital meter. However, a digital meter is not essential. The display of the main meter 4 includes, for example, information related to the speed of the work vehicle 200, time, fuel consumption, turn signal indicator, parking brake lamp, charge lamp indicating abnormality in the charging system, and water temperature gauge indicator showing the state of the radiator device (e.g., temperature measured by the temperature sensor S3).

In the examples shown in FIG. 9A and FIG. 9B, FC meters 6 are placed on both sides of the main meter 4. However, the FC meter 6 may be placed only on one side of the main meter 4, and the shape of each meter is not limited to the illustrated example and can be arbitrary. The FC meter 6 displays information related to the operating state of the FC power generation system 180. In this example embodiment, the FC meter 6 further displays the estimation results of the processor described above as prediction information.

The display of the FC meter 6 on the left side in the examples shown in FIG. 9A and FIG. 9B includes information related to the battery SOC (state of charge) indicating the charging state of the battery pack 80, the remaining amount of fuel (%) in the fuel tank 50, the temperature of the fuel tank (° C.), and the value (kPa) of the sensor S4 (pressure sensor) provided in the fuel tank 50. The display of the FC meter 6 on the left side further includes the power generation state of the FC stack 11, a warning lamp 9 to warn abnormalities in the fuel tank 50, and indicators corresponding to the battery SOC and the remaining amount of fuel, respectively.

In the example shown in FIG. 9A, the FC meter 6 on the right side displays information on the travelable distance, travelable (workable) time, and workable area, which are the estimation results when the implement is driven. While the implement is being driven, the PTO clutch is in a connected state. However, not all of this information needs to be displayed. For example, the travelable distance and travelable time may be displayed, and the workable area information may not be displayed. The FC meter 6 on the right side further displays information on the type of implement and the type of work.

In the example shown in FIG. 9B, the FC meter 6 on the right side displays information on the travelable distance and travelable time, which are the estimation results when the implement is not driven. When the PTO clutch is in a disconnected state, or even when the PTO clutch is in a connected state, if a prediction button (operation button) provided around the driver seat (e.g., in the cabin) is ON, the display of the FC meter 6 on the right side may be configured to switch from the state shown in FIG. 9A to the state shown in FIG. 9B. The prediction button is a button to cause the processor to execute estimation based on the fuel consumption C9.

In this manner, by presenting at least one of the information on travelable distance, travelable time, and workable area, which are the estimation results, to, for example, a driver seated in the driver seat or a user utilizing the operation terminal, it may facilitate prompting the driver or user to make decisions such as refueling, stopping the operation of the implement, or changing the work plan. Furthermore, by presenting information related to the operating state of the FC power generation system to the driver or user, it may facilitate prompting the driver or user to inspect the work vehicle or FC power generation system, for example.

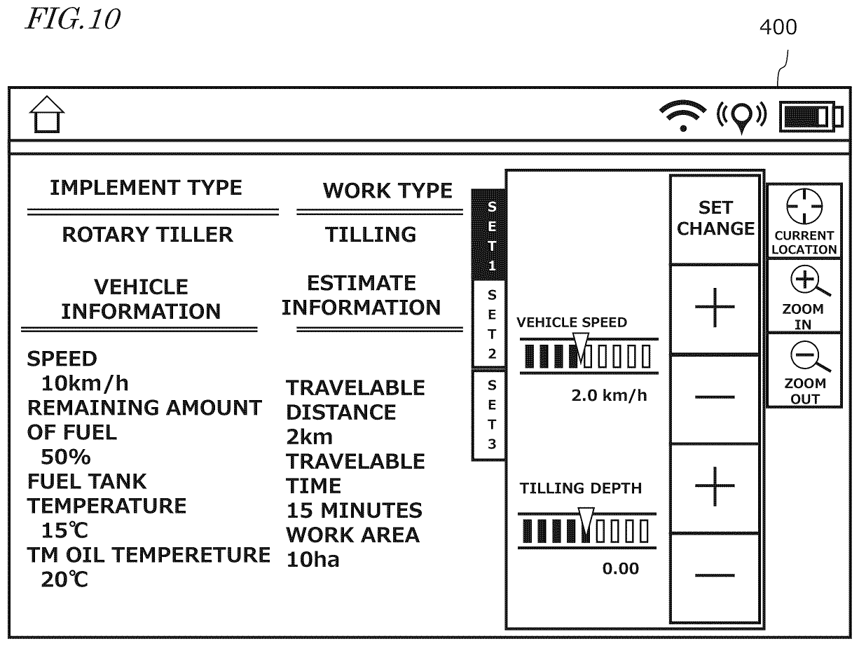

FIG. 10 is a diagram schematically showing another example of displaying estimation results on the display. The display exemplified in FIG. 10 is an operation terminal 400. The screen of the operation terminal 400 may also display the same or similar information as that which may be displayed on the FC meter 6. The screen of the operation terminal 400 exemplified in FIG. 10 displays an input interface to set vehicle speed and plowing depth, and vehicle information, in addition to the type of implement, the type of work, and prediction information.

The processor may calculate at least one of a travelable distance, a travelable area, and a travelable time when the operation of the implement 300 is stopped, and display the calculation results on the display. Compared to operating the implement, stopping the operation of the implement may improve fuel consumption. Therefore, the travelable distance and workable area may expand, and the travelable time may become longer. The processor may estimate at least one of the travelable distance, travelable area, and travelable time based on the fuel consumption or fuel efficiency of the work vehicle 200 and the remaining amount of fuel. This allows, for example, the driver to easily make decisions about stopping the operation of the implement, as they can grasp the prediction information when the operation of the implement is stopped.

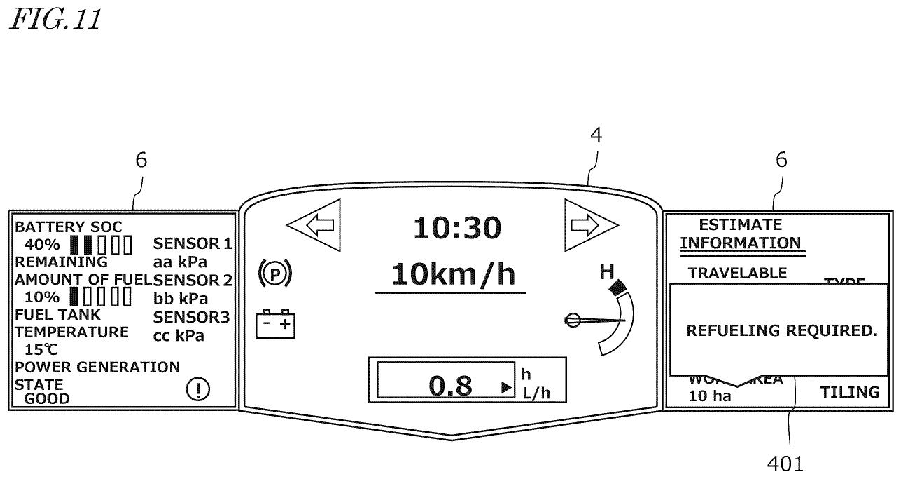

FIG. 11 is a diagram schematically showing an example of a display including information prompting refueling. FIG. 11 shows an example of a digital meter display. The processor may display information prompting refueling on the display when the remaining amount of fuel falls below a threshold value. The threshold value may be set to, for example, about 10% to about 20%. For example, when the remaining amount of fuel (%) falls below the threshold value, the processor may display (pop up) a message 401 such as “Refueling is necessary.” on the FC meter 6 as shown in FIG. 11. Such a display can easily prompt, for example, the driver to refuel.

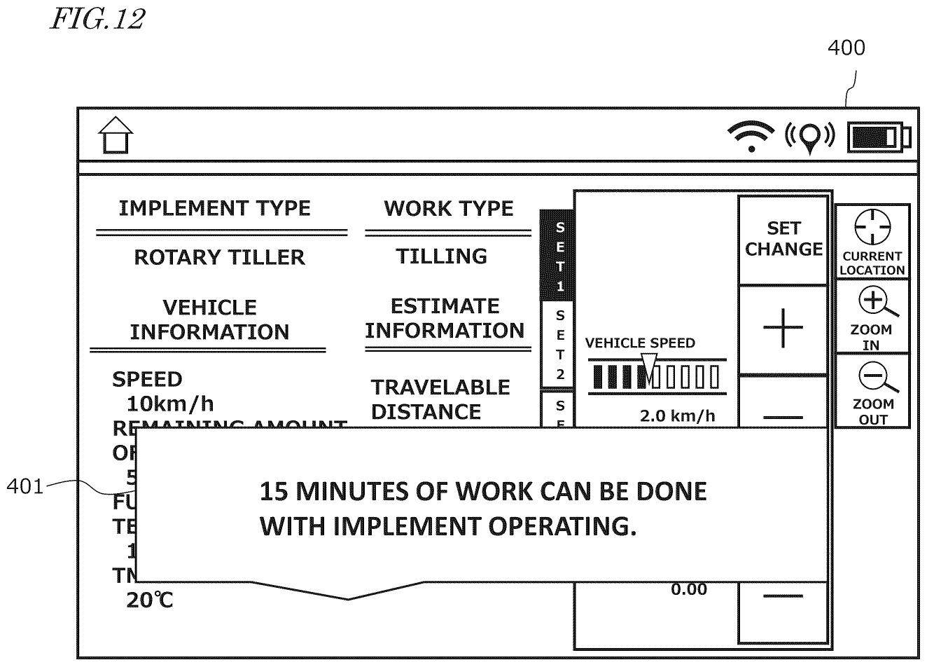

FIG. 12 is a diagram schematically showing an example of a pop-up display including information on travelable time. FIG. 12 shows an example of a display on the screen of the operation terminal 400. The processor may display a pop-up display including prediction information based on the estimation results on the display. As exemplified in FIG. 12, the processor may display (pop up) a message 401 such as “You can work for 15 more minutes with the implement in operation” on the FC meter 6. The message is not limited to the illustrated example, and may be, for example, a message notifying that the remaining amount of fuel is low, a message prompting the replacement of the cartridge of the ion exchanger included in the FC module, or a message prompting to stop in case the implement is detached.

The processor may cause the audio output to output audio based on the estimation results, and/or audio prompting refueling. For example, the processor may cause a speaker to output audio notifying the travelable distance or time based on the estimation results, or audio prompting refueling. Alternatively, the processor may cause a buzzer to output a buzzer sound prompting refueling.

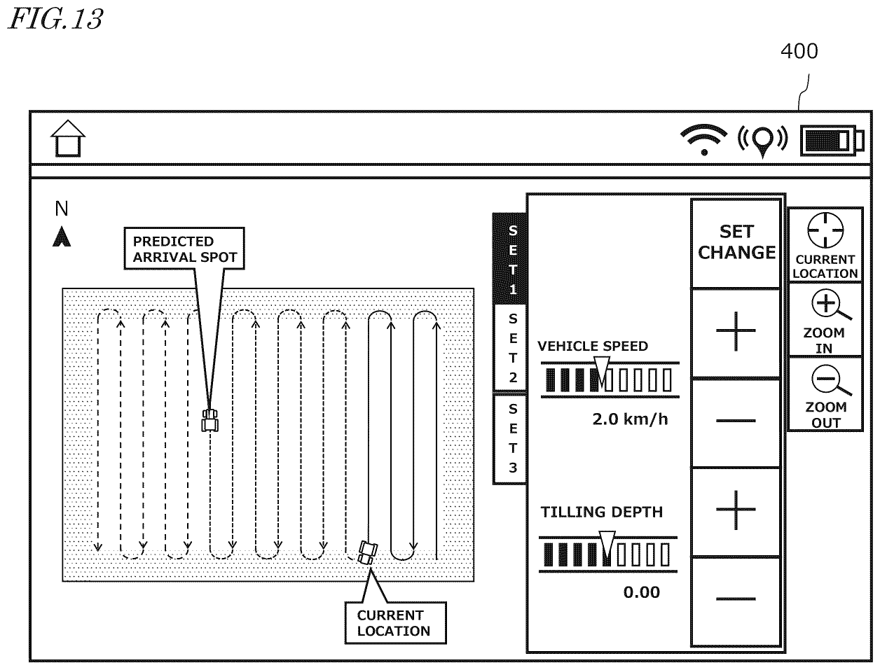

FIG. 13 is a diagram schematically showing an example of a display including map information. The map in the example of the display shown in FIG. 13 includes a target route indicated by arrows set within the field. The work vehicle 200 may further include a GNSS (Global Navigation Satellite System) receiver used for positioning. For example, the main ECU 3 of the work vehicle 200 may automatically travel the work vehicle 200 based on the position of the work vehicle 200 and the information of the target route.

The processor may display, based on the estimation results, map information indicating up to which position in the field work can be performed on the display. The map on the screen of the operation terminal 400 exemplified in FIG. 13 shows the current location of the work vehicle 200 and the predicted arrival spot based on the estimation results. The processor determines the coordinates of the predicted arrival spot in the geographic coordinate system based on, for example, the coordinates of the current location in a geographic coordinate system anchored to the earth, the target route, and the estimated travelable distance. The coordinates in the geographic coordinate system are represented by, for example, latitude and longitude. In this manner, by having the processor display information that visualizes the estimation results on the display, for example, the driver or user can easily make decisions on continuing work or changing the work plan.

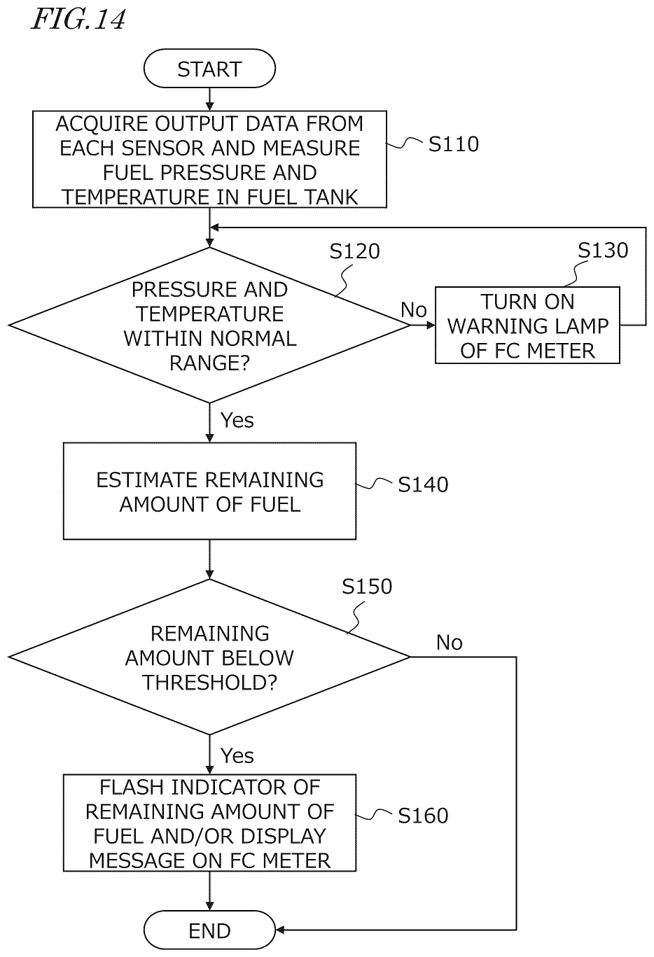

Lastly, an example of the operation of the processor will be described with reference to FIG. 14.

FIG. 14 is a flowchart showing the processing procedure of an example operation of the processor.

First, the processor acquires sensor data output from the temperature sensor of the fuel tank 50 and measures the temperature of the fuel tank 50 based on the sensor data. The processor acquires sensor data output from the sensor S4 (pressure sensor) of the fuel tank 50 and measures the pressure of the fuel in the fuel tank 50 based on the sensor data (step S110).

Next, the processor determines whether each of the temperature of the fuel tank 50 and the pressure of the fuel is within a normal range (step S120). When each value is within the normal range, the process proceeds to the next step S140 (Yes of step $120). When either of the values of the temperature of the fuel tank 50 and the pressure of the fuel is not within the normal range, the processor turns on, for example, the warning lamp 9 of the FC meter 6 (refer to FIG. 9A and FIG. 9B) (No of step S120).

Next, the processor estimates the remaining amount of fuel based on the fuel pressure as described above (S140). The processor determines whether the remaining amount of fuel is less than a threshold value (S150). When the remaining amount of fuel is less than the threshold value (Yes of S150), the processor may, for example, flash the fuel remaining indicator of the FC meter 6 or display a message prompting refueling on the FC meter 6 (S160). Alternatively, when the remaining amount of fuel is less than the threshold value, the processor may display the aforementioned travelable distance, time, or workable area on the FC meter 6.

In one example embodiment, when the implement is being driven (that is, the PTO clutch is in a connected state) and the prediction button is OFF, the processor estimates the travelable distance, travelable time, and travelable area with work based on the fuel consumption C1 to C8 (L/h) shown in FIG. 8, for example. The processor may display the estimated travelable distance, time, and workable area along with the type of work and the type of implement as shown in FIG. 9A.

In another example embodiment, when the implement is not being driven (that is, the PTO clutch is in a disconnected state), or even when the implement is being driven, when the prediction button is ON, the processor estimates the travelable distance and time without work based on the fuel consumption C9 (L/h) when the implement is not driven. The processor may display the estimated travelable distance and time as shown in FIG. 9B.

When the remaining amount of fuel is equal to or greater than the threshold value (No of S150), the process ends.

The configurations and operations of the above example embodiments are merely exemplary, and the present disclosure is not limited to the above example embodiments. For example, various example embodiments may be appropriately combined to configure other example embodiments.

The technologies and example embodiments of this disclosure can be applied to agricultural machines such as tractors, harvesters, rice planters, riding management vehicles, vegetable transplanting machines, mowers, seeders, fertilizer applicators, or agricultural robots.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A work vehicle comprising:
a fuel cell module including a fuel cell stack;
at least one fuel tank to store fuel to be supplied to the fuel cell stack;
a sensor to measure a remaining amount of fuel in the fuel tank;
a motor connected to the fuel cell module;
a power take-off shaft drivable by the motor and connectable to an implement;
a display; and
a processor configured or programmed to estimate, based on the measured remaining amount of fuel and a type of the implement connected to the power take-off shaft and/or a type of work performed by the implement, at least one of a travelable distance, a travelable area, or a travelable time with the work, and to display an estimation result on the display.

2. The work vehicle according to claim 1, wherein the processor is configured or programmed to acquire identification information of the implement from the implement connected to the power take-off shaft and identify the type of the implement and/or the type of work performed by the implement based on the identification information.

3. The work vehicle according to claim 1, wherein the processor is configured or programmed to identify the type of the implement and/or the type of work performed by the implement based on information related to the type of the implement and/or type of work input by a user via an input interface.

4. The work vehicle according to claim 1, further comprising a storage to store data indicating a relationship between the type of the implement and/or the type of work and fuel consumption per unit time; wherein
the processor is configured or programmed to estimate the at least one of the travelable distance, the travelable area, or the travelable time based on the data.

5. The work vehicle according to claim 1, wherein the processor is configured or programmed to calculate at least one of the travelable distance, the travelable area, or the travelable time when operation of the implement is stopped, and display a calculation result on the display.

6. The work vehicle according to claim 1, wherein when the remaining amount of fuel falls below a threshold value, the processor is configured or programmed to display information prompting refueling on the display.

7. The work vehicle according to claim 1, wherein the processor is configured or programmed to display, based on the estimation result, map information indicating up to which position in a field the work can be performed on the display.

8. The work vehicle according to claim 1, further comprising an audio output, wherein the processor is configured or programmed to cause the audio output to output audio based on the estimation result and/or audio prompting refueling.

9. The work vehicle according to claim 1, wherein the sensor includes a pressure sensor to measure pressure of the fuel corresponding to the remaining amount of fuel.

10. The work vehicle according to claim 1, wherein the display includes a meter panel.

11. The work vehicle according to claim 1, wherein the work vehicle is an agricultural machine.
